(19) United States
(12) Patent Application Publication
(10) Pub. No.: US 2024/0241407 A1
(43) Pub. Date: Jul. 18, 2024

(54) ILLUMINATION MODULE FOR ILLUMINATING A SURFACE AND IMAGE GENERATOR UNIT HAVING SUCH AN ILLUMINATION MODULE

(71) Applicant: Carl Zeiss Jena GmbH, Jena (DE)

(72) Inventors: Christoph ERLER, Jena (DE); Marc JUNGHANS, Jena (DE); Markus GIEHL, Jena (DE); Petr VOJTISEK, Jena (DE)

(21) Appl. No.: 18/558,697

(22) PCT Filed: Apr. 28, 2022
(86) PCT No.: PCT/EP2022/061323

§ 371 Date: Nov. 2, 2023

(30) Foreign Application Priority Data
May 5, 2021 (DE) 10 2021 111 673.2

(51) Int. Cl. G02F 1/13357; G02B 5/02

(52) U.S. Cl. CPC G02F 1/133615; G02B 5/0252

(57) ABSTRACT

An illumination module for illuminating a surface has a beam source emitting illumination radiation, an extensive deflection hologram arranged at a distance from the surface to be illuminated, and a collimator optical unit at which the illumination radiation is directed, which collimates the illumination radiation and which emits the latter as collimated radiation incident on the deflection hologram, wherein the deflection hologram is designed such that it deflects the incident collimated radiation in the direction toward the surface to be illuminated and at the same time acts as a diffuser.

### PRIORITY

This application claims the priority of German patent application DE 10 2021 111 673.2 filed May 5, 2021, which is hereby incorporated herein by reference in its entirety.

### FIELD

The present invention relates to an illumination module for illuminating a surface, and to an image generator unit having such an illumination module.

### BACKGROUND

By way of example, such an illumination module and such an image generator unit can be used for a head-up display (HUD). Such HUDs may contain volume-holographic optical units, which are deflecting grating structures that comprise a significant wavelength dependence (dispersion). As a result, the observation angle of the HUD changes with the wavelength, resulting in an HUD blur in the case of broadband illumination. Thus, an image generator unit for such an HUD should comprise spectral lines that are as narrowband as possible.

### SUMMARY

An object of the invention to provide an illumination module for illuminating a surface, by means of which the difficulties described at the outset can be rectified as completely as possible.

By way of the illumination module, it is possible in particular to use a very narrowband illumination radiation for illuminating the surface. On account of the diffuser property of the deflection hologram, a uniform illumination of the surface can advantageously be achieved. Moreover, there advantageously is a reduction in speckle if the illumination radiation is coherent radiation since a mixing of coherence regions not capable of interfering is obtained on account of the diffuser property.

By way of the illumination module, it is hence possible to obtain very narrowband illumination of the surface to be illuminated.

In particular, the beam source may comprise a laser. Thus the beam source is able to output illumination radiation at one wavelength. The beam source may also comprise a plurality of lasers, with the result that the illumination radiation is formed by a plurality of wavelengths (each of which is a very narrowband). For example, this may relate to wavelengths from the red, green, and blue wavelength range.

The deflection hologram may be in the form of a volume hologram in particular. Further, the deflection hologram can be a reflective hologram. Alternatively, it is possible that the deflection hologram is a transmissive hologram.

On account of the diffuser property of the deflection hologram, the deflection hologram also comprises a scattering property which leads to an individual incident beam being deflected within a scattering cone, whereby the desired diffuser effect is achieved.

A substrate body which is transparent to the illumination radiation may be provided, the deflection hologram being formed on the lower side of said substrate body and the upper side of said substrate body being spaced apart from the lower side and being the surface to be illuminated.

Further, the substrate body can comprise a side face through which the collimated radiation enters the substrate body and then strikes the deflection hologram.

An input coupling hologram which is struck by the collimated radiation can be formed on the side face, the input coupling hologram deflecting the incident collimated radiation toward the deflection hologram.

In particular, the input coupling hologram may bring about a deflection in a first plane and the deflection hologram may bring about a deflection in a second plane, with the two planes intersecting. They can preferably intersect at an angle of 90°.

The collimated radiation preferably strikes the input coupling hologram at an angle of incidence of greater than 60°, greater than 65°, greater than 70°, or greater than 75°. Preferably, the angle of incidence is less than 90°, 89°, 88°, 87°, 86°, 85°, 84°, 83°, 82°, 81°, 80°, 79°, 78°, 77°, 76° or 75°.

The input coupling hologram can be a volume hologram. Further, the input coupling hologram can be designed as a transmissive hologram or as a reflective hologram.

In general, what still needs to be mentioned in the context of the development in which the beam source emits illumination radiation at a plurality of wavelengths (e.g., an RGB application) is that the input coupling hologram, if designed as a volume hologram, and the deflection hologram, if designed as a volume hologram, may each be designed such that the volume hologram for the plurality of wavelengths is designed as a layer system (i.e., a respective hologram per wavelength) or as a multiplex hologram (structures for all wavelengths in a hologram).

The collimated radiation strikes the deflection hologram at an angle of incidence of greater than 60°, greater than 65°, greater than 70°, or greater than 75°. In particular, the angle of incidence is less than 90°, 89°, 88°, 87°, 86°, 85°, 84°, 83°, 82°, 81°, 80°, 79°, 78°, 77°, 76° or 75°.

An antireflection layer can be formed on the input coupling hologram and/or a half wave plate layer can be formed between the input coupling hologram and the side face. By way of example, the input coupling hologram and the half wave plate layer can each be formed as a film, with the result that they can be provided together as a film stack.

The illumination radiation emitted by the beam source can be guided to the collimator optical unit via a free beam section, an optical fiber or a combination of optical fiber and free beam section.

The surface to be illuminated can also be an exposed hologram which shows the desired 3-D effect upon illumination. In particular, the illumination radiation can be coherent radiation.

An illumination module according to certain embodiments is used in the image generator unit. A flat light modulator is arranged in the surface to be illuminated or in a surface conjugate thereto, said light modulator, for image creation purposes, modulating the collimated radiation, which is incident thereon and which was deflected by the deflection hologram, in order to create an image. By way of example, the flat light modulator can be a liquid crystal display or a tilting mirror matrix. If it is a liquid crystal display, it is frequently formed on a transparent substrate body. In this case, a further half wave plate film could optionally be introduced between the light modulator and substrate in order to match the polarization direction of the illumination to the preferred direction of the LCD (depends on how the polarizer of the LCD is arranged). The side of the substrate body (which may also be referred to as lower side) opposite the liquid crystal display can then be provided with the deflection hologram. This renders a very compact design possible. Further, the substrate body may then comprise the side face on which the input coupling hologram may subsequently be formed.

The illumination module and/or the image generator unit may comprise a control unit which serves to control the beam source and/or the flat light modulator.

Hence, the illumination module may serve as background illumination or as an edge-lit diffuser in the image generator unit.

The illumination module or the image generator unit may be part of an HUD.

It goes without saying that the features mentioned above and the features yet to be explained hereinafter can be used not only in the specified combinations but also in other combinations or on their own without departing from the scope of the present invention.

The invention will be explained in even greater detail below on the basis of exemplary embodiments with reference to the accompanying drawings, which likewise disclose features essential to the invention. These exemplary embodiments are provided for illustration only and should not be construed as limiting. For example, a description of an exemplary embodiment having a multiplicity of elements or components should not be construed as meaning that all of these elements or components are necessary for implementation. Rather, other exemplary embodiments may also contain alternative elements and components, fewer elements or components, or additional elements or components. Elements or components of different exemplary embodiments can be combined with one another, unless stated otherwise. Modifications and variations that are described for one of the exemplary embodiments can also be applicable to other exemplary embodiments. In order to avoid repetition, elements that are the same or correspond to one another in different figures are denoted by the same reference signs and are not explained repeatedly.

### BRIEF DESCRIPTION OF THE DRAWINGS

FIG. 1 shows a schematic perspective illustration of an exemplary embodiment of the illumination module 1;

FIG. 2 shows a plan view of the illumination module of FIG. 1, with the laser and the control unit not being depicted so as to simplify the illustration;

FIG. 3 shows a side view of the substrate block 4 in the embodiment according to FIG. 1;

FIG. 4 shows a schematic illustration for explaining the diffuser property of the deflection hologram;

FIG. 5 shows a schematic perspective illustration of the substrate block of FIG. 1, together with an exploded illustration of the layer system on the input coupling hologram, and

FIG. 6 shows a further embodiment of the illumination module, in a view in accordance with FIG. 2.

### DETAILED DESCRIPTION

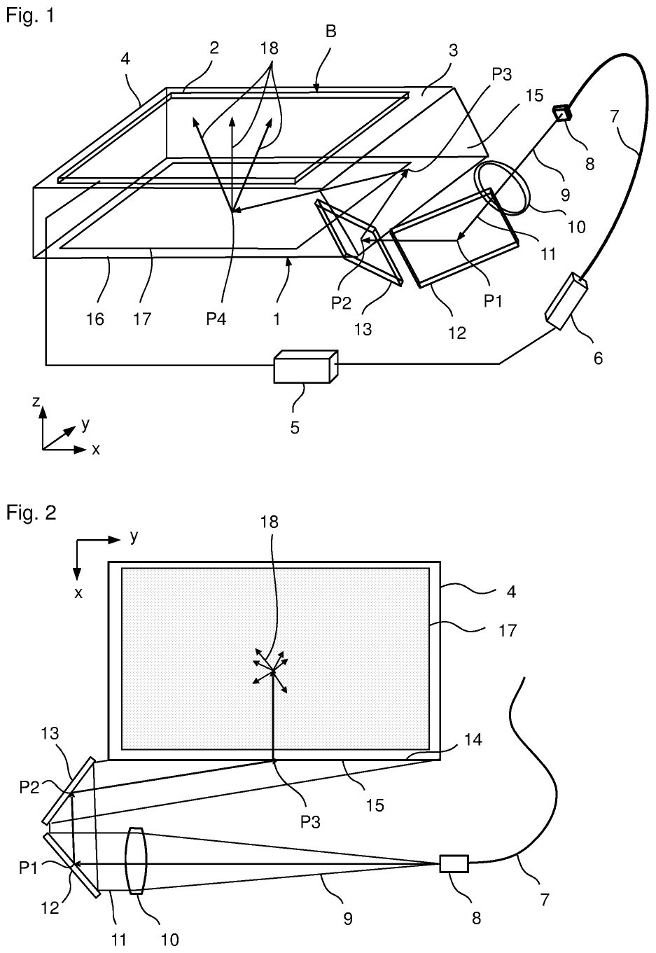

In the exemplary embodiment shown in FIG. 1, the illumination module 1 for illuminating a surface is used to illuminate a liquid crystal display (LCD) 2 formed on an upper side 3 of a substrate block 4. Thus, together the illumination module 1 and the liquid crystal display 2 form an image generator unit B, by means of which images can be created in a manner known per se. To this end, further provision can be made of a control unit 5 for controlling the liquid crystal display 2.

In this case, the illumination module 1 further comprises a laser 6, the laser radiation of which is guided via a fiber 7 to the fiber output 8 of the fiber 7 and is output by the fiber output 8. The emitted laser radiation 9 is then incident on a collimator optical unit 10 of the illumination module 1. The collimator optical unit 10 creates collimated radiation 11 with a diameter of 30 mm. However, to simplify the illustration, only a central ray of the collimated radiation 11 is depicted in FIG. 1. The collimated radiation 11 is deflected by a first and a second deflection mirror 12, 13 (at points P1 and P2) (FIG. 1 and FIG. 2) and directed at an input coupling hologram 15 formed on a side face 14 of the substrate block 4. In this case, the angle of incidence of the collimated radiation 11 on the input coupling hologram 15 is approx. 75° to 80° and is chosen such that the collimated radiation 11 covers the entire input coupling hologram 15 in the y-direction as a result. In this case, the extent of the input coupling hologram 15 in the y-direction is approx. 70 mm. As may be gathered from FIG. 1, for example, the input coupling hologram 15 comprises a flat and rectangular shape with a shorter side of approx. 30 mm such that the entire surface of the input coupling hologram 15 is illuminated by the collimated radiation 11 on account of the deflection of the collimated radiation 11 by means of the two deflection mirrors 12 and 13.

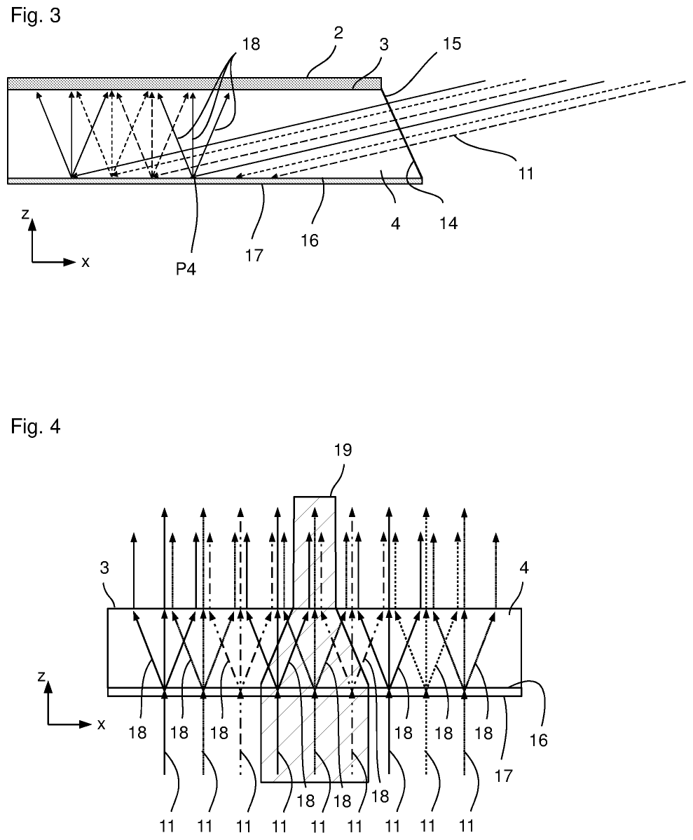

As shown in FIG. 1 and FIG. 3, the substrate block 4 comprises a lower side 16, on which a deflection hologram 17 is formed. The deflection hologram 17 has a flat embodiment and is spaced apart from the liquid crystal display 2 (in the z-direction on account of the extent of the substrate block 4). The deflection hologram 17 is preferably arranged parallel to the liquid crystal display 2.

In this case, the deflection hologram 17 is designed such that (at the point P4 for the central ray of the collimated radiation 11) it deflects the incident collimated radiation 11 (which is incident on the deflection hologram 17 on account of the deflection—at the point P3 for the central ray of the collimated radiation 11—by means of the input coupling hologram 15) such that it propagates substantially in the z-direction and consequently runs through the substrate block 4, which is transparent to the laser radiation 9, 11, to the upper side 3 and thus illuminates the liquid crystal display 2 from behind.

The deflection of the collimated radiation 11 by means of the input coupling hologram 15 is implemented such that the deflected collimated radiation 11 illuminates the entire deflection hologram 17 in the x-direction. An angle of incidence ranging from 75 to 80° is again chosen to this end.

However, the deflection hologram 17 does not only carry out the above-described deflection in the direction of the upper side 3, but additionally also comprises the function of a diffuser. As indicated in FIGS. 1 to 3, each beam of the collimated radiation 11 which strikes the deflection hologram 17 is additionally scattered such that a scattering cone 18 is created. Hence, individual rays of the collimated radiation 11 are mixed on the upper side 3 and are incident on the deflection hologram 17 at different points of incidence. As a result, the coherence length is also reduced, as depicted schematically in FIG. 4. To simplify the illustration, the assumption is made in FIG. 4 that the deflection hologram 17 is not a reflective deflection hologram 17 like in the above-described embodiment, but rather is a transmissive deflection hologram 17. As is clearly evident from this illustration, the created scattering cones 18 lead to a mixing of the points of incidence on the deflection hologram 17 up to the upper side 3, with the result that a more uniform illumination of the upper side 3 is possible. Moreover, this advantageously also reduces the coherence length, as indicated by the hatched region 19 in FIG. 4. This advantageously leads to a speckle reduction.

The embodiment described in FIGS. 1 to 3 is distinguished by a very high degree of compactness. Hence, it is possible to provide an illumination module 1 and an image generator unit B, which each have a very compact embodiment. The laser radiation 9 of the laser 6 need not be guided to the collimator optical unit 10 via a fiber. Naturally, a free beam system is also possible. A combination of a fiber 7 and a free beam system or free beam section is also possible.

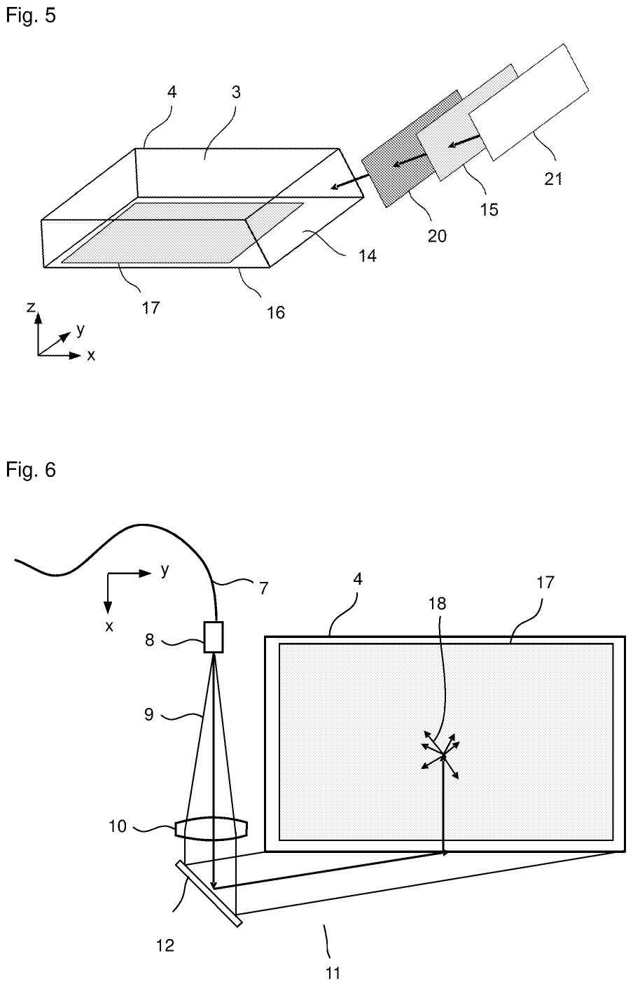

What can be gathered from the schematic detailed view of the substrate block 4 with the deflection hologram 17 and the layer arrangement for the input coupling hologram 15 depicted in the exploded representation in FIG. 5 is that, in addition to the input coupling hologram 15, a half wave plate film 20 may also be provided between the input coupling hologram 15 and the side face 14 and an antireflection coating 21 may be provided on the input coupling hologram 15. In the case of polarized radiation, the half wave plate film 20 leads to the polarization direction being rotated through 90°.

Only one deflection mirror 12 is required in the exemplary embodiment shown in FIG. 6, which shows a plan view in the same manner as in FIG. 2.

In the previous description, the assumption was made that the laser 6 emits only laser radiation 9 at one wavelength. In this way, a monochromatic image can be created by means of the liquid crystal display 2. Naturally, it is also possible for the laser 6 to be designed such that it for example emits red, green, and blue laser radiation, with the result that this can be used to create a color image.

The laser radiation can be very narrowband on account of the use of the laser 6. Despite this narrowband laser radiation, it is possible to obtain a very homogeneous and uniform illumination on the surface 3, and hence on the liquid crystal display 2. At the same time, unwanted speckle can be reduced or avoided.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

1-10. (canceled)

11. An illumination module for illuminating a surface, comprising:
a beam source that emits illumination radiation;
a flat deflection hologram which is arranged at a distance from a surface to be illuminated; and
a collimator optical unit, at which the illumination radiation is directed and which collimates the illumination radiation and emits the latter as collimated radiation which strikes the deflection hologram,
wherein the deflection hologram is configured such that it deflects the incident collimated radiation in the direction of the surface to be illuminated and, in the process, acts as a diffuser at the same time.

12. The illumination module as claimed in claim 11, wherein a substrate body which is transparent to the illumination radiation is provided, the deflection hologram being formed on the lower side of said substrate body and the upper side of said substrate body being spaced apart from the lower side and being the surface to be illuminated.

13. The illumination module as claimed in claim 12, wherein the substrate body comprises a side face through which the collimated radiation enters the substrate body and then strikes the deflection hologram.

14. The illumination module as claimed in claim 13, wherein an input coupling hologram which is struck by the collimated radiation is formed on the side face, the input coupling hologram deflecting the incident collimated radiation toward the deflection hologram.

15. The illumination module as claimed in claim 14, wherein the collimated radiation strikes the input coupling hologram at an angle of incidence greater than 60°.

16. The illumination module as claimed in claim 15, wherein the input coupling hologram is a transmissive hologram.

17. The illumination module as claimed in claim 14, wherein the input coupling hologram is a transmissive hologram.

18. The illumination module as claimed in claim 11, wherein the collimated radiation strikes the deflection hologram at an angle of incidence greater than 60°.

19. The illumination module as claimed in claim 11, wherein the deflection hologram is a reflective hologram.

20. The illumination module as claimed in claim 11, wherein the beam source comprises a laser.

21. An image generator unit comprising an illumination module as claimed in claim 11, wherein a flat light modulator is arranged in the surface to be illuminated or in a surface conjugate thereto, said light modulator, for image creation purposes, modulating the collimated radiation, which is incident thereon and which was deflected by the deflection hologram, in order to create an image.
